(19) United States
(12) Patent Application Publication
(10) Pub. No.: US 2022/0412074 A1
(43) Pub. Date: Dec. 29, 2022

(54) SEALING TAPE FOR SEALING CONSTRUCTION JOINTS

(71) Applicant: Tremco CPG Germany GmbH, Bodenwoehr (DE)

(72) Inventors: Martin HUEBSCHMANN, Schmidgaden (DE); Markus KOMMA, Burglengenfeld (DE)

(21) Appl. No.: 17/769,719

(22) PCT Filed: Oct. 2, 2020
(86) PCT No.: PCT/EP2020/077760

§ 371 Date: Apr. 15, 2022

(30) Foreign Application Priority Data
Oct. 15, 2019 (DE) 10 2019 127 665.9

(51) Int. Cl. E04B 1/68

(52) U.S. Cl. CPC E04B 1/6812

(57) ABSTRACT

A sealing strip is prefabricated in the form of a sealing strip roll having a foam support which extends in a specified longitudinal direction, a width direction perpendicular to the longitudinal direction, and a thickness direction, wherein the foam support has a first primary surface defined by the longitudinal direction and the width direction and a second primary surface defined by the longitudinal direction and the width direction, the second primary surface lying opposite the first primary surface, and the foam support additionally has a first secondary surface defined by the longitudinal direction and the thickness direction and a second secondary surface defined by the longitudinal direction and the thickness direction. At least one secondary surface is coated with a sealing compound and/or at least one secondary surface is heat-treated.

The present invention relates to a sealing tape, in particular for construction joints. Such sealing tapes or sealing strips have been known in the prior art for a long time. They are inserted, for example, into the joints between windows and masonry or between soffits. The problem here is that a certain amount of air can still pass through in the direction of the respective building joint or gap.

Therefore, sealing tapes are known from the prior art that have sealing foils or the like on the outer surfaces or in their interior. The manufacture of such sealing tapes in the prior art is sometimes relatively complex. For example, foam carriers are cut into and foils are inserted into the respective cuts.

The present invention is therefore based on the object of providing a simplified sealing tape which, in particular, also poses fewer problems in production or can be produced with less effort. According to the invention, this is achieved by a sealing tape according to the independent claims and in the method of a corresponding sealing tape. Advantageous embodiments and further developments are the subject matter of the subclaims.

A sealing tape fabricated as a sealing tape roll comprises a foam carrier extending in a predetermined length direction, a width direction perpendicular to said length direction and a thickness direction, wherein said thickness direction preferably being perpendicular to said length direction and to said width direction, wherein the carrier having a first main surface formed by the length direction and the width direction and a second main surface formed by the length direction and the width direction, the second main surface being opposite to the first main surface and/or spaced from the first main surface and wherein the carrier further having a first secondary surface formed by the length direction and the thickness direction and a second secondary surface formed by the length direction and the thickness direction, wherein the second secondary surface being opposite to the first secondary surface and/or spaced from the first secondary surface.

Preferably, the main surfaces therefore limit the foam carrier in its thickness direction and the secondary surfaces limit the foam support in the width direction.

According to the invention, at least one secondary surface is coated with a sealing compound and/or heat-treated. For example, it would be possible for this secondary surface to have been melted in the course of a manufacturing process in order to become airtight.

These secondary surfaces, which are also referred to as lateral surfaces, are the respective outer surfaces of the sealing tape roll, i.e. those surfaces which have a plurality of layers of sealing tape rolled up on top of each other.

It would also be possible that the other secondary surface is also coated with a sealing compound and/or that the other secondary surface is also heat treated.

Particularly preferably, the sealing compound is a compound containing, for example, silicone or hybrid adhesive.

Preferably, the substance or the adhesive mass is applied evenly in the circumferential direction and/or in the radial direction of the sealing tape roll. In this way, an even distribution of the sealing layer is achieved later.

In addition, hot melt adhesives can also be used. These have polymers or base polymers that are preferably selected from a group of base polymers that includes PA (polyamide), PE (polyethylene), APAO (amorphous polyalphaolefins), EVAC (ethylene-vinyl acetate copolymer) and TPE (thermoplastic copolyester elastomers), TPU (urethane-based thermoplastic elastamers), TPA (thermoplastic polyamide elastomers). In addition, wax and in particular synthetic wax can also be used.

Particularly preferably, this sealing compound is elastic or has a certain elasticity. Particularly preferably, however, the elasticity of this sealing compound is less than the elasticity of the foam carrier.

However, it would also be possible to use a non-elastic sealing compound. For example, a very stiff curing compound could be used, which does not stretch and which does not expand with it.

Particularly preferably, however, this sealing compound has an elasticity that is high enough that it does not tear even if the carrier and/or the sealing tape expands. In this way, the surface or secondary surface that is provided with the sealing compound remains airtight even in a reset state of the foam carrier.

However, as mentioned, the sealing compound does not have to be elastic, but it should be ensured that the sealing compound does not tear or form cracks.

In this way, a sealed side surface is created for the mounting condition of the sealing tape.

Particularly preferably, this sealing compound or the sealant used is airtight or substantially airtight. By substantially airtight it is understood that the sealing compound allows less air to pass through than the foam carrier on which it is arranged. Thus, in an expanded state of the sealing tape, this sealing compound fulfils the purpose of preventing the passage of air even through the foam.

Preferably, the sealing compound covers several layers of the foam carrier in the rolled-up state of the sealing tape and particularly preferably all layers of the foam carrier. In a further advantageous embodiment, this sealing compound is applied over the entire surface of the secondary surface and/or is applied over the entire surface of a side surface of the sealing tape roll in the rolled-up state of the sealing tape roll.

Preferably, the sealing compound in the state applied to the secondary surface has such elasticity and/or tear strength that it tears when the sealing tape is unrolled.

Particularly preferably, the sealing tape is wound onto a roll core.

In a further preferred embodiment, the foam carrier is impregnated. In particular, the foam carrier is impregnated for delayed recovery.

In a preferred embodiment, the foam is an open-cell foam. In a further preferred embodiment, the foam is a polyurethane foam.

Preferably, the foam carrier has a thickness (measured along the thickness direction) greater than 5 mm, preferably greater than 10 mm and preferably greater than 15 mm and particularly preferably greater than 20 mm.

In a further preferred embodiment, the foam carrier has a thickness that is less than 100 mm, preferably less than 80 mm, preferably less than 70 mm, preferably less than 60 mm, preferably less than 50 mm, preferably less than 40 mm, and particularly preferably less than 35 mm.

In a further preferred embodiment, a cover layer is arranged on at least one of the main surfaces. This cover layer can completely cover the main surface. Additionally or alternatively, it is possible that at least one of the main surfaces of the foam carrier is heat-treated, for example partially melted as described above, in order to also achieve an airtightness of the main surface in this way.

For example, it would be conceivable that a thermoplastic foam is used as the top layer foam, or if one (or both) of the layers is equipped with hot melt foil, which can then be melted and spread.

As mentioned above, this cover layer also serves to prevent the passage of air.

In a further preferred embodiment, the cover layer is a further foam layer and in particular a foam layer which is impermeable to air. This further foam layer can, for example, be arranged or adhered to the foam carrier by means of a self-adhesive layer. However, there may also be an additional adhesive with which the cover layer is adhered to the foam carrier. Furthermore, it would be possible for the cover layer to be laminated to the foam carrier. It is also possible that the cover layer is attached to the foam carrier by means of an adhesive, in particular but not exclusively a hot melt adhesive.

However, it would also be possible for the cover layer to be a plastic material or even a sprayed-on substance.

It is possible that an adhesive film or an adhesive layer in general can also act as an airtight layer. In this case, it may not be necessary to apply another airtight layer to the foam carrier. For example, it can be achieved that an additional airtight layer is arranged on the foam carrier on only one side or unilateral and an adhesive layer takes over this function on the other side.

In a further preferred embodiment, a self-adhesive film (SK) can also perform the function of the airtight layer.

In a further preferred embodiment, the cover layer, in particular if it is formed as a foam layer, has a thickness which is greater than 0.5 mm, preferably greater than 1 mm, preferably greater than 1.5 mm. Particularly preferably, this cover layer has a thickness that is less than 10 mm, preferably less than 8 mm, preferably less than 6 mm.

In a further preferred embodiment, the above-mentioned sealing compound is elastic and in particular elastic in the thickness direction, but as mentioned above preferably less elastic than the foam carrier.

In a further preferred embodiment, in an expanded state of the sealing tape, the sealing compound at the secondary surface merges into the further cover layer or directly adjoins it and, in particular, also without gaps.

Preferably, in a rolled-up state of the sealing tape, the sealing compound is both arranged and, in particular, adhered to the secondary surfaces of the foam carrier and to side surfaces of the cover layers.

Preferably, at least one of the cover layers, and preferably both cover layers, has in each case two main surfaces extending in the length direction and the width direction, and also two secondary surfaces extending in the length direction and the thickness direction.

Preferably, the sealing compound is also arranged on at least one secondary surface of at least one cover layer and preferably in each case on at least one secondary surface of both cover layers.

In general, the main surfaces could also be called main top-surfaces and the secondary surfaces could also be called secondary top-surfaces.

In a further preferred embodiment, a cover layer is also arranged on the other of the two main surfaces. In this embodiment, the foam carrier is therefore arranged between the two cover layers. It is possible that the second cover layer is also designed in the same way as the first cover layer and, in particular, can also be designed as a further foam layer.

Preferably, the second cover layer is also impermeable to air.

In a further preferred embodiment, an adhesive force of the sealing compound to the foam carrier and/or at least one of the cover layers and in particular both cover layers is greater than a tearing force required to tear the sealing compound. In this way, when the sealing tape is unrolled, it can be achieved that the sealing compound tears in the area between two layers in each case and does not tear off from one or the other foam material.

The same layer thickness of the sealing compound is used as a basis for comparing the tear strength and the adhesive force.

In a further preferred embodiment, an adhesive force of the sealing compound to at least one and preferably both cover layers is greater than an adhesive force of the sealing compound to the foam carrier. In this way, it can be achieved that the sealing compound remains on the cover layers when the foam carrier expands.

However, conversely, it would also be possible for an adhesive force of the sealing compound to the foam carrier to be greater than an adhesive force of the sealing compound to at least one and preferably both cover layers.

Preferably, the foam carrier is arranged in its thickness direction between the two cover layers.

In a further preferred embodiment, an adhesive element and in particular a self-adhesive layer is arranged on at least one cover layer. However, it would be possible for an adhesive layer to be arranged on both cover layers. In this way, the sealing tape can be adhered to an element of a structure such as a window frame.

In a further preferred embodiment, it is also possible that a further cover agent, such as in particular a so-called liner, is arranged on the cover layer. However, it would also be possible for the sealing tape roll to be designed without a liner and, in particular, for an adhesive layer of the cover layer to lie directly against a further cover layer.

The present invention further relates to a sealing tape comprising a foam carrier extending in a predetermined length direction, a width direction perpendicular to the length direction, and a thickness direction, wherein the carrier having a first main surface formed by the length direction and the width direction and a second main surface formed by the length direction and the width direction, the second main surface being opposite to the first main surface and wherein the carrier further comprising a first secondary surface formed by the length direction and the thickness direction and a second secondary surface formed by the length direction and the thickness direction.

According to the invention, a first cover layer is arranged on at least one main surface and a second cover layer is arranged on the second main surface and a sealing compound and in particular an elastic sealing compound is arranged on at least one of the secondary surfaces and/or at least one secondary surface is heat-treated. Particularly preferably, the foam carrier is an impregnated foam carrier.

In a further preferred embodiment, a self-adhesive layer is also arranged on one of the two cover layers. Preferably, this self-adhesive layer also acts as an airtight layer.

Particularly preferably, the two cover layers are impermeable to air.

Particularly preferably, the cover layers are non-resettable or only slightly resettable, whereas the foam carrier itself is resettable. In a further design, the features correspond to the features mentioned above in relation to the sealing tape roll. However, it would also be conceivable that one or both cover layers are largely or even completely recoverable.

The present invention further relates to a method of manufacturing a sealing tape and in particular a sealing tape roll. A foam carrier is first provided which extends in a length direction and a width direction perpendicular thereto and a thickness direction perpendicular to the length direction and the width direction. The carrier has a first main surface formed by the length direction and the width direction and a second main surface formed by the length direction and the width direction, which second main surface is opposite the first main surface.

In a further method step, the foam carrier is rolled up into a large roll and in a further step, a plurality of individual rolls are cut from this large roll. This cutting is preferably done in a direction that is perpendicular to an axis of rotation of the roll carrier. Preferably, the cutting is done in the length direction of the foam carrier.

In a further method step, at least one side surface of the individual rolls is coated with a sealing compound. Additionally or alternatively, it is also possible that this side surface is heat treated, for example melted.

It is possible that this sealing compound is spread, but it would also be possible that the sealing compound is sprayed on. It is possible that the sealing compound is applied to the entire side surface of the sealing tape roll, but it is also possible that this sealing compound is applied to the individual roll layers in strips.

In a further preferred embodiment, a cover layer is applied to at least one of the main surfaces before the roll-up. Preferably, this cover layer is applied before the foam carrier is wound up into a large roll. This can be done, for example, by gluing on this cover layer. In a preferred embodiment, a cover layer is applied to both main surfaces of the foam carrier. In this way, a U-shaped envelope of the foam carrier is created overall by an airtight material in an expanded state of the sealing tape. In a preferred embodiment, the foam carrier is compressed when the sealing tape is rolled up or beforehand.

Preferably, the foam carrier is sandwiched between the two cover layers.

In a further preferred embodiment, an adhesive, such as in particular but not exclusively a self-adhesive film, is also applied to at least one of the cover layers.

Further advantages and embodiments can be seen in the attached drawings.

In the drawings:

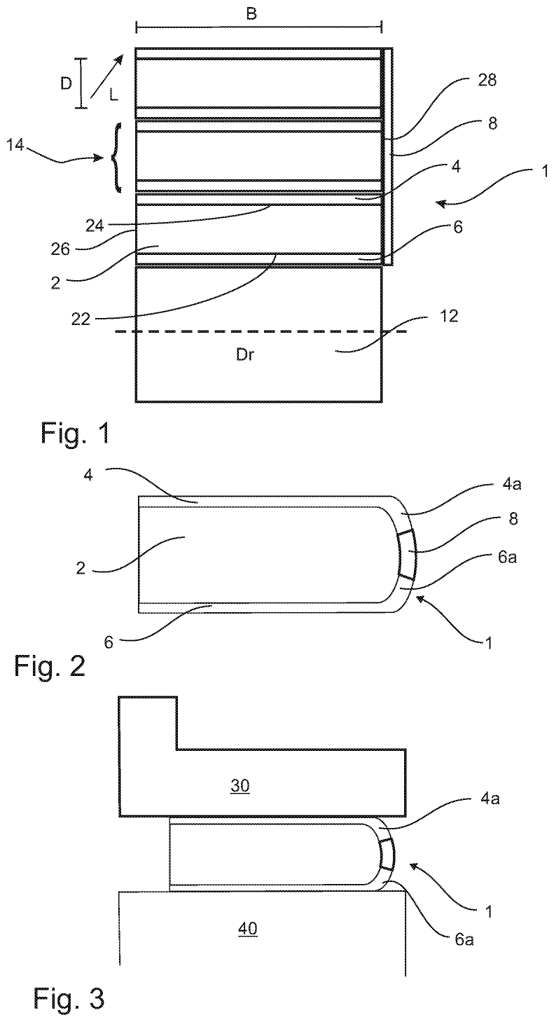

FIG. 1 shows a sectional view of a sealing tape roll according to the invention;

FIG. 2 shows a view of a sealing tape in an expanded state;

FIG. 3 shows a view of a sealing tape in a construction joint;

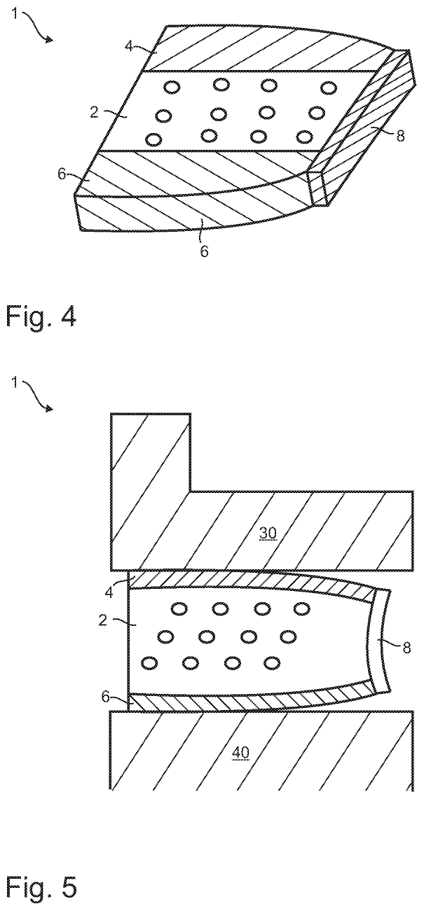

FIG. 4 shows a further view of a sealing tape in an expanded state; and

FIG. 5 shows a view of the sealing tape from FIG. 4 in a construction joint.

FIG. 1 shows a sealing tape roll 1 in a rolled-up state, wherein three layers of sealing tape are shown here, which are arranged or rolled up one above the other. The reference sign 12 indicates a roll core on which the sealing tape is rolled up. The reference sign Dr indicates a roll axis of the sealing tape roll 1. In FIGS. 2 and 3, however, the reference sign 1 indicates the sealing tape but not in a state made up as a roll.

Each sealing tape layer 14 has a foam carrier 2 on which a first cover layer 4 and a second cover layer 6 are arranged. The reference signs 22 and 24 indicate main surfaces of the foam carrier 2 which extend in a width direction B and a length direction L. This length direction here extends perpendicular to the plane of the figure and runs in an overall spiral around the roll core 12.

An adhesive or sealing compound 8 is arranged on a secondary surface 28. This can be applied to this surface in the process.

When the sealing tape is pulled off the sealing tape roll, the sealing compound 8 will tear in each case at the set points between the individual layers 14 and thus remain piece by piece on the respective secondary surfaces 28 of the sealing tape.

FIG. 2 shows a sealing tape in an expanded state. Here again the foam carrier 2 can be seen as well as the two cover layers 4 and 6. When the foam is expanded, the sealing compound 8 will also expand to a certain extent. Since the sealing compound 8 is also adhered to the two cover layers 4 and 6, it will merge into them in an expanded state so that no gap occurs between the sealing compound 8 and the cover layers 4 and 6.

FIG. 3 shows an arrangement of a sealing tape 1 according to the invention in a construction joint between two building parts 30 and 40, for example a brickwork and a window reveal.

It can be seen here that air cannot pass through the joint from right to left, as it is prevented from doing so by the sealing compound 8 on the one hand, but also by the sections 4a or 6a of the cover layers 4 and 6 on the other hand. In this way, air can be prevented from passing through the construction joint or through the sealing tape.

FIG. 4 shows a sealing tape in an expanded state in an advantageous embodiment. Here again the foam carrier 2 can be seen as well as the two cover layers 4 and 6. When the foam is reset or expanded, the sealing compound 8 will also expand to a certain extent, but remains attached to the cover layers. In this case, the sealing compound extends along the entire height of the foam carrier, wherein there is no gap between the sealing compound 8 and the cover layers 4 and 6.

FIG. 5 shows an arrangement of a sealing tape 1 according to the invention from FIG. 4 in a construction joint between two building parts 30 and 40, for example a brickwork and a window reveal.

It can be seen here that air cannot pass through the joint from right to left, as it is prevented from doing so by the sealing compound 8 on the one hand, but also by the cover layers 4 and 6 on the other hand. In this way, air can be prevented from passing through the construction joint or through the sealing tape.

The applicant reserves the right to claim all features disclosed in the application documents as essential to the invention, provided they are individually or in combination new compared to the prior art. It is further pointed out that the individual figures also describe features which may be advantageous in themselves. The skilled person immediately recognises that a certain feature described in a figure can also be advantageous without adopting further features from this figure. Furthermore, the skilled person recognises that advantages can also result from a combination of several features shown in individual figures or in different figures.

### LIST OF REFERENCE SIGNS

1 sealing tape roll
2 foam carrier
4 first cover layer
4a section of the cover layer
6 second cover layer
6a section of the cover layer
8 adhesive or sealing compound
12 roller core
14 sealing tape layers
22 main surface of the foam carrier
24 main surface of the foam carrier
26, 28 secondary surface
30 building part
40 building part
B width direction
L length direction
Dr roll axis

1-10. (canceled)

11. A sealing tape fabricated as a sealing tape roll comprising a foam carrier extending in a predetermined length direction, a width direction perpendicular to said length direction and a thickness direction, wherein the foam carrier has a first main surface formed by the length direction and the width direction and a second main surface formed by the length direction and the width direction, the second main surface is opposite to the first main surface, and wherein the foam carrier further comprises a first minor surface formed by the length direction and the thickness direction and a second minor surface formed by the length direction and the thickness direction,
wherein
at least one secondary surface is coated with a sealing compound and/or at least one secondary surface is heat-treated, and a cover layer is arranged on at least one of the two main surfaces, wherein the cover layer being a foam layer.

12. The sealing tape according to claim 11,
wherein
the foam carrier is impregnated.

13. The sealing tape according to claim 11,
wherein
the further foam layer is impermeable to air.

14. The sealing tape according to claim 11,
wherein
the foam carrier has a thickness which is greater than 10 mm, preferably greater than 15 mm and particularly preferably greater than 20 mm and/or that the foam carrier has a thickness which is less than 100 mm, preferably less than 50 mm, preferably less than 40 mm and particularly preferably less than 35 mm.

15. The sealing tape according to claim 13,
wherein
a cover layer is also arranged on the other of the two main surfaces.

16. The sealing tape according to claim 14,
wherein
at least one of the two cover layers is made airtight.

17. The sealing tape according to claim 14,
wherein
the cover layer has a thickness which is greater than 0.5 mm, preferably greater than 1 mm and/or the cover layer has a thickness which is less than 10 mm, preferably less than 8 mm, preferably less than 6 mm.

18. The sealing tape according to claim 11,
wherein
the second cover layer is also designed in the same way as the first cover layer and, in particular, is also designed as a further foam layer.

19. A sealing tape comprising a foam carrier extending in a predetermined length direction, a width direction perpendicular to the length direction and a thickness direction, wherein the carrier has a first main surface formed by the length direction and the width direction and a second main surface formed by the length direction and the width direction, the second main surface is opposite to the first main surface, and wherein the carrier further comprises a first secondary surface formed by the length direction and the thickness direction and a second secondary surface formed by the length direction and the thickness direction,
wherein
a cover layer is arranged on at least one main surface, and at least one secondary surface is coated with a sealing compound and/or at least one secondary surface is heat-treated, and a cover layer is arranged on at least one of the two main surfaces, wherein the cover layer being a foam layer.

20. A method of manufacturing a sealing tape roll comprising the steps of:
providing a foam carrier extending in a length direction, a width direction perpendicular thereto and a thickness direction perpendicular to the length direction and the width direction, wherein the foam carrier having a first main surface formed by the length direction and the width direction and a second main surface formed by the length direction and the width direction, the second main surface being opposite to the first main surface, wherein a cover layer is applied to at least one main surface before rolling up, wherein the cover layer is a foam layer;
rolling up the foam carrier on a large roll;
cutting the large roll into a plurality of individual rolls; and
coating at least one side surface of the individual rolls with a sealing compound and/or heat treating at least one of these side surfaces.

21. The method according to claim 20,
wherein
a cover layer is also arranged on the other of the two main surfaces.

22. The sealing tape according to claim 12,
wherein
the further foam layer is impermeable to air.

23. The sealing tape according to claim 12,
wherein
the foam carrier has a thickness which is greater than 10 mm, preferably greater than 15 mm and particularly preferably greater than 20 mm and/or that the foam carrier has a thickness which is less than 100 mm, preferably less than 50 mm, preferably less than 40 mm and particularly preferably less than 35 mm.

24. The sealing tape according to claim 13,
wherein
the foam carrier has a thickness which is greater than 10 mm, preferably greater than 15 mm and particularly preferably greater than 20 mm and/or that the foam carrier has a thickness which is less than 100 mm, preferably less than 50 mm, preferably less than 40 mm and particularly preferably less than 35 mm.

25. The sealing tape according to claim 22,
wherein
a cover layer is also arranged on the other of the two main surfaces.

26. The sealing tape according to claim 15,
wherein
at least one of the two cover layers is made airtight.

27. The sealing tape according to claim 15,
wherein
the cover layer has a thickness which is greater than 0.5 mm, preferably greater than 1 mm and/or the cover layer has a thickness which is less than 10 mm, preferably less than 8 mm, preferably less than 6 mm.

28. The sealing tape according to claim 22,
wherein
the second cover layer is also designed in the same way as the first cover layer and, in particular, is also designed as a further foam layer.

29. The sealing tape according to claim 22,
wherein
at least one of the two cover layers is made airtight.

30. The sealing tape according to claim 25,
wherein
the cover layer has a thickness which is greater than 0.5 mm, preferably greater than 1 mm and/or the cover layer has a thickness which is less than 10 mm, preferably less than 8 mm, preferably less than 6 mm.
